(19) United States
(12) Patent Application Publication
(10) Pub. No.: US 2026/0060200 A1
(43) Pub. Date: Mar. 5, 2026

(54) EXCREMENT TREATMENT MATERIAL AND METHOD FOR MANUFACTURING THE SAME

(71) Applicant: DAIKI CO., LTD., Tokyo (JP)

(72) Inventor: Shinobu HATANAKA, Tokyo (JP)

(73) Assignee: DAIKI CO., LTD., Tokyo (JP)

(21) Appl. No.: 19/382,370

(22) Filed: Nov. 7, 2025

Related U.S. Application Data
(63) Continuation of application No. PCT/JP2024/016933, filed on May 7, 2024.

(30) Foreign Application Priority Data
Jun. 6, 2023 (JP) 2023-092836

(51) Int. Cl. A01K 1/015; B01J 20/24; B01J 20/28; B01J 20/30; G01N 21/80

(52) U.S. Cl. CPC A01K 1/0154; A01K 1/0155; B01J 20/24; B01J 20/28011; B01J 20/28016; B01J 20/3028; G01N 21/80

(57) ABSTRACT

An excrement treatment material includes a granule that absorbs animal urine. The granule contains an additive, and an indicator. The additive dissolves in animal urine to change the pH of the urine. The indicator changes color depending on the pH of the urine in which the additive has dissolved.

### CROSS REFERENCE TO RELATED APPLICATION

This is a Continuation of International Application No. PCT/JP2024/016933 filed May 7, 2024, which claims the benefit of Japanese Application No. 2023-092836 filed Jun. 6, 2023. The contents of these applications are hereby incorporated by reference in their entirety.

### TECHNICAL FIELD

The present invention relates to an excrement treatment material and a method for manufacturing the same.

### Background Art

A conventional excrement treatment material is disclosed, for example, in Patent Document 1. The excrement treatment material disclosed in Patent Document 1 is composed of a plurality of granules that absorb animal urine. Each granule contains a pH indicator in addition to pulverized nonwoven fabric and an adhesive. For that reason, in this excrement treatment material, the granules change color depending on the pH of the animal urine.

### CITATION LIST

### Patent Document

Patent Document 1: JP 2000-333547 A

### SUMMARY OF INVENTION

### Technical Problem

The pH indicator is thus contained in the granules to change color depending on the pH of the animal urine. Therefore, there is restriction that the pH indicator must have a color change range that includes the pH of the urine of the animal (target animal) using the excrement treatment material. This restriction has been a factor in reducing the degree of freedom in selecting a pH indicator in conventional excrement treatment materials.

### Solution to Problem

The present invention has been made in view of the above-described problem, and it is an object thereof to provide an excrement treatment material having a high degree of freedom in selecting a pH indicator, and a method for manufacturing the same.

An excrement treatment material according to the present invention includes: a granule that absorbs animal urine, wherein the granule contains an additive that dissolves in the urine to change pH of the urine, and a pH indicator that changes color depending on pH of the urine in which the additive has dissolved.

In this excrement treatment material, the granule is provided that contains the additive that dissolves in urine to change the pH of the urine. In this case, the pH indicator does not need to have a color change range that includes the pH of the original urine (the urine before the additive dissolves), as long as the color change range includes the pH of the urine in which the additive has dissolved. This eliminates the restriction that the pH indicator must have a color change range that includes the pH of urine of the target animal.

A method for manufacturing an excrement treatment material according to the present invention includes: a granule forming step of forming a granule that absorbs animal urine, wherein in the granule forming step, the granule is formed that contains an additive that dissolves in the urine to change pH of the urine, and a pH indicator that changes color depending on pH of the urine in which the additive has dissolved.

In this manufacturing method, the granule is formed that contains the additive that dissolves in urine to change the pH of the urine. In this case, the pH indicator does not need to have a color change range that includes the pH of the original urine, as long as the color change range includes the pH of the urine in which the additive has dissolved. This eliminates the restriction that the pH indicator must have a color change range that includes the pH of urine of the target animal.

### Advantageous Effects of Invention

According to the present invention, it is possible to implement an excrement treatment material having a high degree of freedom in selecting a pH indicator, and a method for manufacturing the same.

### BRIEF DESCRIPTION OF DRAWINGS

FIG. 1 is a schematic view showing an embodiment of an excrement treatment material according to the present invention.

FIG. 2 is a schematic view showing a granule 10.

### DESCRIPTION OF EMBODIMENTS

Hereinafter, an embodiment of the present invention will be described in detail with reference to the drawings. In the description of the drawings, the same elements are given the same reference numerals, and a redundant description will be omitted.

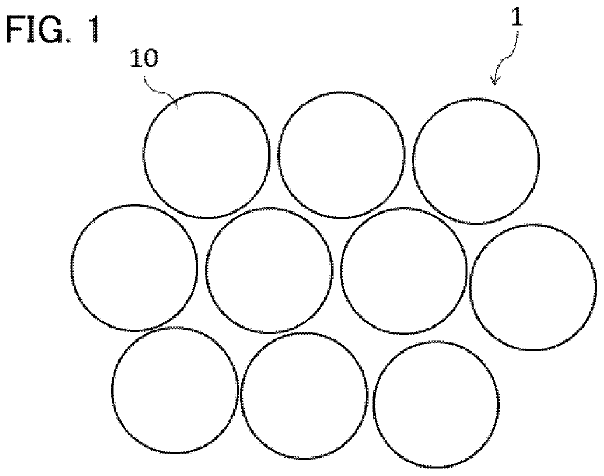

FIG. 1 is a schematic view showing an embodiment of an excrement treatment material according to the present invention. An excrement treatment material 1 is an excrement treatment material that is used for treating excrement (mainly urine) of animals such as cats or dogs. The excrement treatment material 1 includes a plurality of granules 10. The excrement treatment material 1 is used, for example, in a state in which the plurality of granules 10 are laid in a box-shaped toilet.

Each granule 10 has a water absorbing property, and absorbs animal urine. That is, each granule 10 takes urine in the inside thereof and retains it. The granules 10 having the water absorbing property require the water absorption rate of 40% or more measured by the following test. First, approximate 50 grams of the granules 10 (sample) are placed in a sieve with the inner diameter of 10 cm and the mesh size of 1 mm. An empty beaker is set under the sieve. Then, 30 ml of water is dripped on the sample over 10 seconds using a syringe with the inner diameter of its outer cylinder of 3 cm and the inner diameter of its cylinder tip of 4 mm (60 ml syringe manufactured by Terumo Corp.). After waiting 1 minute, the quantity of the water in the beaker is measured. The ratio of the value obtained by subtracting the measured water quantity from the quantity of the dripped water (30 ml) with respect to the quantity of the dripped water shall be the water absorption rate. That is, if the water quantity in the beaker is 18 ml or less, the water absorption rate is 40% or more, and therefore the granules 10 are found to have the water absorbing property.

Each granule 10 has a granular shape. Examples of the granular shape include a sphere, column, and ellipsoid. The particle diameter of each granule 10 is, for example, between 5 mm and 30 mm inclusive. As used herein, the particle diameter of the granule 10 is defined as the diameter of the minimum sphere that can include the granule 10. It is preferable that each granule 10 contains an organic substance as its main material. As used herein, the main material of the granule 10 refers to one of the materials constituting the granule 10 that accounts for the highest weight ratio in the granule 10. Examples of the organic substance that is the main material of the granule 10 include papers, plants, plastics, and organic sludge.

The papers refer to a material made mainly of pulp. As the papers, in addition to ordinary paper (paper powder) and pulp, for example, fluff pulp, paper derived from vinyl chloride wallpaper (paper generated during manufacturing or classifying vinyl chloride wallpaper), paper derived from a gypsum board (paper generated during manufacturing or classifying a gypsum board), or paper derived from a sanitary article (paper generated during manufacturing or classifying a sanitary article that contains paper) can be used. Examples of the sanitary article containing paper include paper diapers, sanitary napkins, urine absorbing pads, and sanitary paper (tissue paper, toilet paper, paper towels, or the like). As the plants, for example, wood powder, sawdust, or a plant residue (used tea leaves, bean curd lees, or the like) can be used. As the plastics, in addition to ordinary plastic, for example, plastic derived from vinyl chloride wallpaper (plastic generated during manufacturing or classifying vinyl chloride wallpaper), or plastic derived from a sanitary article (plastic generated during manufacturing or classifying a sanitary article that contains plastic) can be used. Examples of the sanitary article containing plastic include paper diapers, sanitary napkins, urine absorbing pads, and sanitary masks. As the organic sludge, for example, papermaking sludge, or pulp sludge can be used.

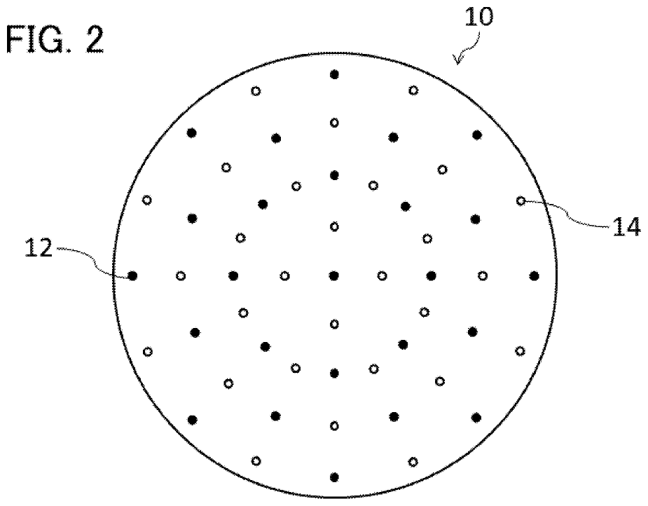

FIG. 2 is a schematic view showing the granule 10. Each granule 10 contains an additive 12, and an indicator 14. The additive 12 dissolves in urine to change the pH of the urine. That is, the pH of the urine in which the additive 12 has dissolved (a solution containing urine as a solvent and the additive 12 as a solute) is different from the pH of the original urine (urine before the additive 12 dissolves in the urine). In the present embodiment, the pH of an aqueous solution of the additive 12 is higher than the pH of the original urine. As the additive 12, for example, borax (sodium tetraborate decahydrate) can be used. The additive 12 is contained in the granule 10 in a solid state. That is, in the granule 10 before use (before absorbing urine), the additive 12 has not dissolved in liquid and is in a dry state. It is preferable that the whole additive 12 contained in the granule 10 is in a solid state.

The indicator 14 is a pH indicator, and changes color depending on the pH of the urine in which the additive 12 has dissolved. The indicator 14 has a color change range that includes the pH of the urine in which the additive 12 has dissolved. The indicator 14 may or may not have a color change range that includes the pH of the original urine. In the present embodiment, the indicator 14 contains a natural pigment that changes color depending on pH. As the indicator 14, for example, turmeric powder or butterfly pea powder can be used. Turmeric powder and butterfly pea powder contain curcumin and anthocyanin, respectively, as the natural pigment.

The additive 12 may change the pH of urine so that the indicator 14 exhibits a first color when the pH of the urine is normal, and exhibits a second color when the pH of the urine is abnormal. The amount of pH change can be adjusted by the type and content of the additive 12 or the like. The second color is different from the first color. The first and second colors preferably have different hues, for example, the first color being yellow or orange and the second color being red.

As a specific example, consider a case where the target animal of the excrement treatment material 1 is a cat and the indicator 14 is turmeric powder. The normal pH of cat urine is between 6.0 and 6.8 inclusive. Turmeric powder (curcumin) turns red when the pH is about 8.5 or more. Therefore, the additive 12 may be contained so that the changed pH of the urine becomes about 8.5 when the pH of the original urine is 6.8. By doing so, the indicator 14 exhibits yellow or orange when the pH of the original urine is at a normal value of 6.8 or below, whereas the indicator 14 exhibits red when the pH of the original urine is at an abnormal value above 6.8.

In the present embodiment, the granule 10 is made only of the main material described above, the additive 12, and the indicator 14. The weight ratios of the main material, the additive 12, and the indicator 14 with respect to each granule 10 are, for example, between 80% and 95% inclusive, between 0.1% and 5% inclusive, and between 1% and 20% inclusive, respectively. The specific composition of the granule 10 is, for example, 89 wt% of pulp, 1 wt% of borax (the additive 12), and 10 wt% of turmeric powder or butterfly pea powder (the indicator 14).

Each granule 10 is a granulated material having an uncovered surface. In detail, each granule 10 is a granulated material obtained by granulating a granulating material (materials constituting each granule 10). Each granule 10 is not provided with a coating layer (a layer that covers a part or the entirety of the surface of the granulated material). Therefore, each granule 10 has a single-layer structure composed of a homogeneous granulated material.

In the excrement treatment material 1, when an animal urinates, the urine is absorbed by the granules 10. The additive 12 then dissolves in the urine absorbed by the granule 10, causing the pH of the urine to change. The indicator 14 then changes color depending on the changed pH of the urine, which in turn causes the granules 10 to change color. This allows the user (such as the animal owner) to visually confirm the coloration of the indicator 14.

Next, an example of a method for manufacturing the excrement treatment material 1 will be described as an embodiment of a method for manufacturing an excrement treatment material according to the present invention. This manufacturing method includes a granule forming step.

The granule forming step is a step of forming the granules 10. The granule forming step includes a granulating step of forming granulated materials that constitute the granules 10. In the granulating step, the granulated materials are formed by granulating the granulating material (the main material, the additive 12 and the indicator 14) with a granulation apparatus. In the present embodiment, the granulating material is granulated without adding water. That is, no water is added to the granulating material before or after granulation. As the granulation apparatus, for example, an extrusion granulator can be used. Prior to the granulation, pretreatment such as pulverization, and kneading is performed on the granulating material as needed. After the granulation, posttreatment such as sieving (sizing), and drying is performed as needed. Accordingly, the excrement treatment material 1 composed of the plurality of granules 10 is obtained.

The effects of the present embodiment will be described. In the present embodiment, the granule 10 is formed that contains the additive 12 that dissolves in urine to change the pH of the urine. In this case, the indicator 14 does not need to have a color change range that includes the pH of the original urine, as long as the color change range includes the pH of the urine in which the additive 12 has dissolved. This eliminates the restriction that the indicator 14 must have a color change range that includes the pH of urine of the target animal. Accordingly, the excrement treatment material 1 having a high degree of freedom in selecting the indicator 14, and a method for manufacturing the same are implemented.

In other words, the pH of the original urine cannot be controlled. For that reason, if an attempt is made to match the color change range of a pH indicator to the pH of the original urine, the range of pH indicators available for selection is naturally narrowed. In contrast, the pH of urine in which the additive 12 has dissolved can be controlled by adjusting the amount of pH change caused by the additive 12 as described above. For that reason, if the color change range of the pH indicator is matched to the changed pH of the urine, the range of pH indicators available for selection can be broadened. That is why the excrement treatment material 1 has a high degree of freedom in selecting the indicator 14.

In the case where the indicator 14 exhibits the first color when the urine pH is normal, and exhibits the second color when the urine pH is abnormal, it is easy to determine whether the urine is abnormal based on the difference in coloration of the indicator 14. In the case where the indicator 14 exhibits different colors depending on whether the urine pH is normal or not in this way, the excrement treatment material 1 is useful for understanding the health condition of the target animal.

However, it is not essential that the indicator 14 exhibits different colors depending on whether the urine pH is normal or not. Regardless of whether the pH is normal or not, if the indicator 14 changes color when the granule 10 absorbs urine, it is possible to visually distinguish between used granules 10 (granules 10 that have absorbed urine) and unused granules 10 (granules 10 that have not absorbed urine). This is useful for selectively removing used granules 10 from a large number of granules 10.

The additive 12 is contained in the granule 10 in a solid state. In this case, the additive 12 reacts with the indicator 14 only after dissolving in urine. This makes it possible to prevent the indicator 14 from changing color before the granules 10 are used.

In the granulating step, the granulating material is granulated without adding water. This makes it possible to easily form the granules 10 containing the additive 12 in a solid state.

The pH of an aqueous solution of the additive 12 is higher than the pH of the original urine. In this case, the pH of the urine after the additive 12 has dissolved can be made higher than the pH of the original urine. This makes it possible to use a pH indicator having a color change range in the alkaline region as the indicator 14 even if the original urine is acidic.

Borax has the property that the pH does not change significantly even when the concentration of the aqueous solution changes. For example, the pH of a borax aqueous solution (20° C.) is 9.3 when the concentration is 0.1%, 9.2 when the concentration is 1.0%, and 9.2 when the concentration is 2.0%. For this reason, when borax is used as the additive 12, there is an advantage that it is easy to finely adjust the amount of pH change of urine.

The indicator 14 contains a natural pigment that changes color depending on pH. Natural pigments have the property of being less likely to fade once their color changes, compared to synthetic reagents such as a BTB solution. For this reason, it is easy to confirm the coloration of the indicator 14 even after a long time (e.g. about 8 hours) has passed since the animal urinated. Because animals often urinate while the user is out or asleep, it is useful to be able to confirm the coloration of the indicator 14 even after such a long time has passed.

The larger the content of the indicator 14, the easier it is to visually recognize the coloration of the indicator 14. From this viewpoint, it is preferable that the weight ratio of the indicator 14 with respect to the granule 10 is 1% or more. On the other hand, if the content of the indicator 14 is too large, the water absorbing property, which is the original function of the granules 10, may be impaired. From this viewpoint, it is preferable that the above-described weight ratio is 20% or less.

In the case where the granules 10 contain an organic substance as the main material, it is possible to obtain the granules 10 suitable for being disposed of by incineration. This contributes to convenience of disposal of the used granules 10.

In the case where the granules 10 contain papers as the main material, because the main material is white or close to white, there is an advantage that the coloration of the indicator 14 is easily visible.

The granules 10 are a granulated material having an uncovered surface. In this case, because the entire surface of the granulated material (the granule 10) is exposed, it is easy to visually recognize the coloration of the granulated material (the coloration of the indicator 14).

The present invention is not limited to the above-described embodiment, and various modifications can be made. In the above-described embodiment, an example is given in which borax is used as the additive 12. However, calcium carbonate, potassium carbonate, or sodium phosphate may be used as the additive 12.

In the above-described embodiment, an example is given in which the pH of an aqueous solution of the additive 12 is higher than the pH of the original urine. However, the pH of the aqueous solution of the additive 12 may be lower than the pH of the original urine. In that case, the pH of the urine after the additive 12 has dissolved can be made lower than the pH of the original urine.

In the above-described embodiment, an example is given in which the indicator 14 contains a natural pigment. However, a synthetic reagent such as a BTB solution or a phenolphthalein solution may be used as the indicator 14.

In the above-described embodiment, an example is given in which the granules 10 have a single-layer structure composed only of an uncovered granulated material. However, the granules 10 may have a multi-layer structure (double-layer structure) composed of a granulated material and a coating layer. That is, the surface of the granulated material may be covered, as long as the coloration of the indicator 14 is visible.

### LIST OF REFERENCE NUMERALS

1 Excrement Treatment Material
10 Granule
12 Additive
14 Indicator (pH Indicator)

1. An excrement treatment material comprising:
a granule that absorbs animal urine,
wherein the granule contains
an additive that dissolves in the urine to change pH of the urine, and
a pH indicator that changes color depending on pH of the urine in which the additive has dissolved.

2. The excrement treatment material according to claim 1,
wherein the additive changes pH of the urine so that the pH indicator exhibits a first color when pH of the urine is normal, and exhibits a second color different from the first color when pH of the urine is abnormal.

3. The excrement treatment material according to claim 1,
wherein the additive is contained in the granule in a solid state.

4. The excrement treatment material according to claim 1,
wherein pH of an aqueous solution of the additive is higher than pH of the urine before the additive dissolves therein.

5. The excrement treatment material according to claim 1,
wherein the additive is borax.

6. The excrement treatment material according to claim 1,
wherein a weight ratio of the additive with respect to the granule is between 0.1% and 5% inclusive.

7. The excrement treatment material according to claim 1,
wherein the pH indicator contains a natural pigment that changes color depending on pH.

8. The excrement treatment material according to claim 7,
wherein the natural pigment is curcumin or anthocyanin.

9. The excrement treatment material according to claim 1,
wherein a weight ratio of the pH indicator with respect to the granule is between 1% and 20% inclusive.

10. The excrement treatment material according to claim 1,
wherein the granule contains an organic substance as a main material.

11. The excrement treatment material according to claim 10,
wherein the granule contains papers as the main material.

12. The excrement treatment material according to claim 1,
wherein the granule is a granulated material having an uncovered surface.

13. A method for manufacturing an excrement treatment material, the method comprising:
a granule forming step of forming a granule that absorbs animal urine,
wherein in the granule forming step, the granule is formed that contains an additive that dissolves in the urine to change pH of the urine, and a pH indicator that changes color depending on pH of the urine in which the additive has dissolved.

14. The method for manufacturing an excrement treatment material according to claim 13,
wherein in the granule forming step, the granule is formed that contains the additive that changes pH of the urine so that the pH indicator exhibits a first color when pH of the urine is normal, and exhibits a second color different from the first color when pH of the urine is abnormal.

15. The method for manufacturing an excrement treatment material according to claim 13,
wherein in the granule forming step, the granule is formed in which the additive is contained in a solid state.

16. The method for manufacturing an excrement treatment material according to claim 15,
wherein the granule forming step includes a granulating step of forming a granulated material that constitutes the granule, and
in the granulating step, the granulated material is formed by granulating a granulating material without adding water.

17. The method for manufacturing an excrement treatment material according to claim 13,
wherein pH of an aqueous solution of the additive is higher than pH of the urine before the additive dissolves therein.

18. The method for manufacturing an excrement treatment material according to claim 13,
wherein the additive is borax.

19. The method for manufacturing an excrement treatment material according to claim 13,
wherein in the granule forming step, the granule is formed such that a weight ratio of the additive with respect to the granule is between 0.1% and 5% inclusive.

20. The method for manufacturing an excrement treatment material according to claim 13,
wherein the pH indicator contains a natural pigment that changes color depending on pH.
